(19) United States
(12) Patent Application Publication
(10) Pub. No.: US 2023/0037899 A1
(43) Pub. Date: Feb. 9, 2023

(54) ELECTRONIC AND AUTOMATIC AWNING

(71) Applicant: Abdullah ALALWAN, Riyadh (SA)

(72) Inventor: Abdullah ALALWAN, Riyadh (SA)

(21) Appl. No.: 17/789,080

(22) PCT Filed: Nov. 29, 2020
(86) PCT No.: PCT/SA2020/050018

§ 371 Date: Jun. 24, 2022

(30) Foreign Application Priority Data
Dec. 26, 2019 (SA) 119410323

(51) Int. Cl. E04H 6/04

(52) U.S. Cl. CPC E04H 6/04

(57) ABSTRACT

The current invention is related to designing an automatic awning. It is used to protect the vehicle or the persons desiring to sit outside during the daytime from the sun and its heat. It includes only one pillar fixed to the ground or on a fixed wall (FIG. 2). This pillar contains the closed awning inside. The pillar contains also a motor with a chain to push the awning making it go out smoothly (FIG. 3) from the pillar and turn into a cross-rail (FIG. 4). Then, the awning is opened containing two awnings fixed to the cross-rail. Each awning is opened against the other direction of the other one. Each awning folded in a cylindrical shape contains its special fabric and arm with a tie rod. It has a spring and a chain set up in a special way to be very specific in pushing force out. It is fixed to the cylinder and the fabric to open the fabric awning (FIG. 5). There is a motor inside the cylinder. It pulls and closes the fabric by wrapping around the cylinder. Each awning is spread horizontally in a reverse direction to give the desired shade (FIG. 6). The sizes of the awning vary according to the size of the required shade, as it is enlarged to increase the desired shade, and vice versa. There are three sensors in each awning. One of them is the sun sensor to be opened at daytime and closed at night, the wind sensor that closes in case of strong winds and a sensor of radio frequency (RFID) attached to the designated vehicle to be opened in case of proximity and closed in case of being away. The awning is opened either by pressing the remote-control button, and this is a manual option, and there is an automatic option. It is through a barcode reader, the sensor of radio frequency (RFID), in a card set inside the vehicle linked to the awning. When the vehicle is parked under the awning, it is automatically opened in case of the sunny weather. The process of closing the awning is done either manually by remote control or automatically in the following cases; when the vehicle moves away from its place and the awning, also in case of the absence of the sun, and also in the case of the fast wind.

### INVENTION BACKGROUND

The invention is a device of an electric awning that operates automatically to achieve and create a shade used to protect from the sun's rays, whether for vehicles or outdoor sessions. The closest cases of this awning are:
The traditional fixed awnings which are fixed and set outside homes to make shade for vehicles. They are made of iron and fabric. They are fixed to the ground or fixed on the internal or external walls of the house.
The electrical awnings which are fixed on the building or on two pillars and are opened in one direction.
Single-pillar awnings which are circular like a large umbrella to shade the outdoor session.

The reasons why the current awnings do not achieve what the product does are:
The fixed awning occupies space especially when it is not required while this invention does not occupy space, but rather in the form of a lighting pole when it is closed.
The traditional awnings, in case of the absence of a vehicle, are an obstacle to the traffic, especially for large vehicles.
The traditional awnings distort the house look.
The fixed awnings, in case of they are not needed and at night, block air and views of the place.
The fixed awnings are prone to being uprooted, in case of the strong winds and they can't resist it, causing damage to the property and the human beings.
In case of the presence of more than one awning on the same street, they distort the view.
The movable awning needs a fence or a wall to be fixed on, or two or more pillars to be fixed on, distorting the place and creating a large and unacceptable appearance.

### THE GENERAL DESCRIPTION OF THE PRODUCT (INVENTION)

Because of the damage caused by the hot rays of the sun to the vehicles or humans and the need to find an alternative solution, whether for fixed awnings outside the fence, which the regime prevents in a number of countries such as the Kingdom of Saudi Arabia for several reasons such as distorting the outside view of the house and the neighborhood in general, hindering the traffic of vehicles, especially for the large ones, and causing danger in case of the strong winds. Also, the awnings used for shading the outdoor sessions are exposed to the winds and it is difficult to set them in some locations where there are no fixed things, such as walk and pillars. This forces the person to put a traditional awning which may be exposed to the strong winds. The automatic awnings which are currently available also require fixing on the house or on the fence of the house directly, while the vehicle is usually some distance from the fence of the house due to the sidewalk and also the afforestation. In addition, the outdoor sessions may not be near the building or from a fixed pillar.

Therefore, the idea of a movable awning appeared to be opened only during the daytime and on parking the designated vehicle, which has a device the awning recognizes on parking directly. In case of the strong winds, the awning is directly folded thanks to the wind sensor. Also it is automatically closed in the absence of the sun and in case there are no vehicles under the awning so that it does not hinder the movement of the large vehicles on the roads. In addition, it does not distort the view of the house as it is closed at night and when the vehicle is not under it. Its shape does not distort the general view as it is fixed on only one pillar and adjacent to the vehicle's parking to create shade only for the area allocated for the vehicle without extending to more areas. Rather, it is a beautiful view by which the roads are decorated.

It does not occupy space when it is closed. This plays a great role in achieving protection from the heat and rays of the sun. It operates automatically without the need for human intervention to open and close.

### A BRIEF EXPLANATION OF THE DRAWINGS

FIG. 1: A detailed view of the product (invention) with the most important parts.

FIG. 2: A view of the awning in case of closure.

FIG. 3: A view of the beginning of opening the awning and the mechanism to open and close it.

FIG. 4: A view of the pillar stability and the awning's readiness to spread.

FIG. 5: A view of the completion of the exit of the two awnings and the completion of the opening of the awning,

FIG. 6: A view of the awning shape, the vehicle under it and the shape of the shade underneath.

FIG. 7: A view of the three stages which the awning goes through, from full closure, then initial opening, then full opening.

### DETAILED DESCRIPTION

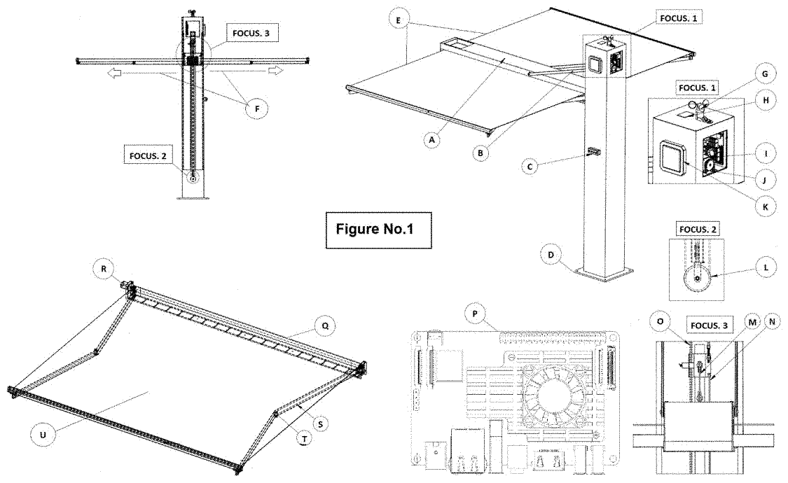

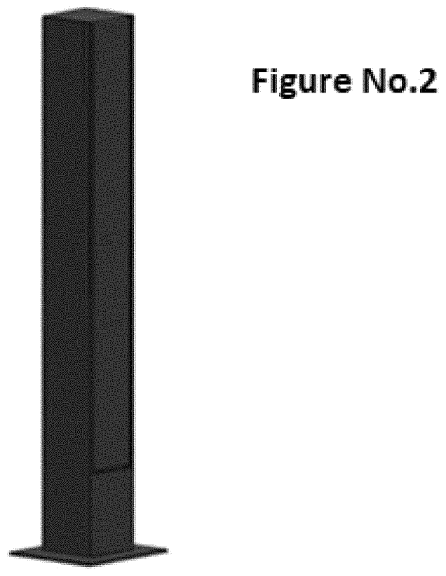

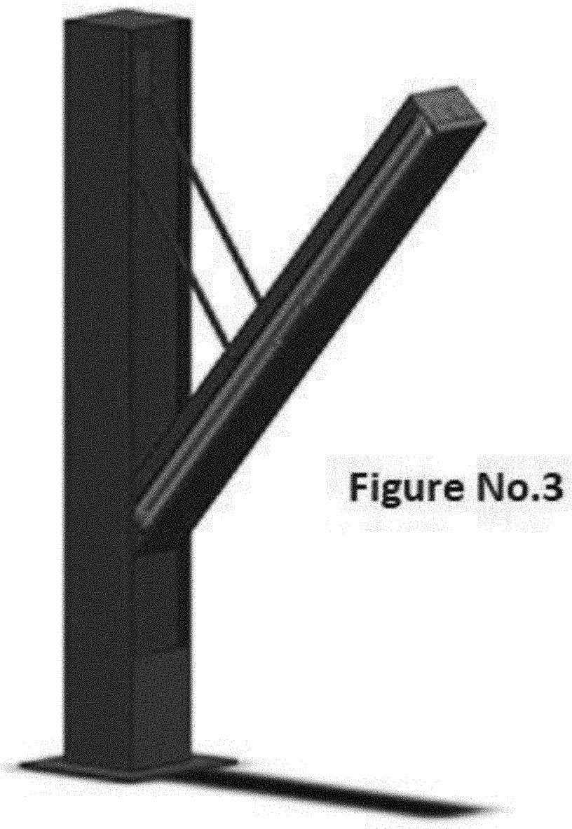

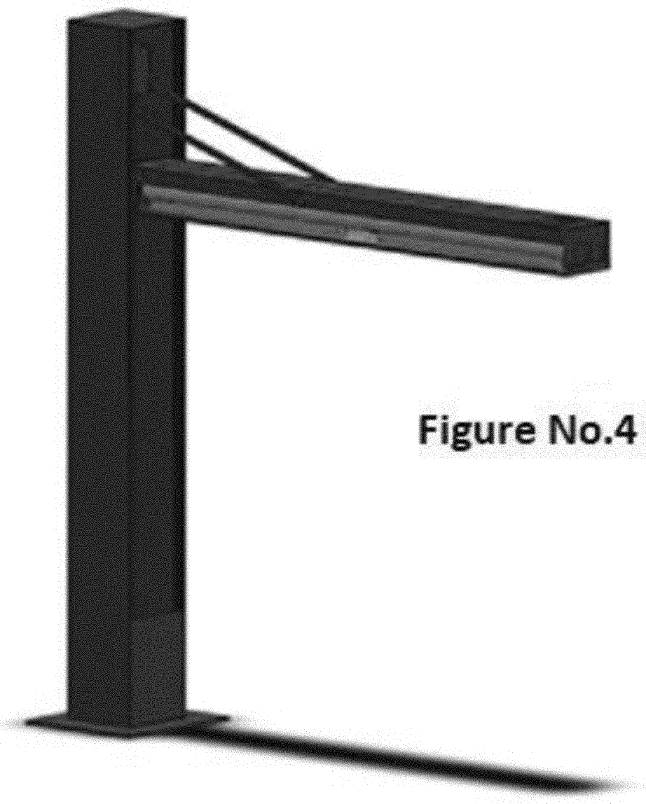

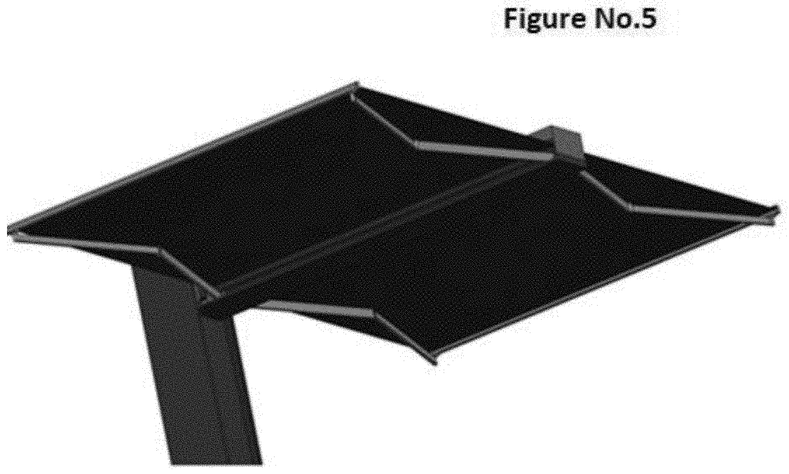

The product is just a one pillar. Its length is determined according to the area of shade to be created as it may get smaller or bigger (the product has more than one size). The pillar has an awning inside. It also contains a motion motor (FIG. 1 I), a wind sensor (FIG. 1 G), a sun sensor (FIG. 1 H) and a barcode reader of radar frequency (RFID) (FIG. 1 K). This pillar is fixed to the ground or on a stable wall. When the awning is opened, whether with the remote control or by proximity of the vehicle that has a tape of radio frequency (RFID), the pillar picks up these coded vibrations (RFID) to start going out and opening (FIG. 2) provided that the sun shines at this moment and there is no wind. The awning is pushed by a power motor tied to a chain that pushes the awning out (FIG. 3). The awning begins to be opened, and as a first stage, it turns into a pillar with a cross-rail only as in (FIG. 4). After that, it pushes arms (FIG. 1 S) fixed with two cylinders (FIG. 1 Q) and a fabric attached to them (FIG. 1 U) out in opposite directions (FIG. 1 F). The push is made because the arms are composed of a spring and a compressed chain (FIG. 1 T but held by the fabric wrapped around the two cylinders (FIG. 1 Q). Inside them, there are two motors (FIG. 1 R) to push and release for opening and closing, thus the awning has been fully opened (FIG. 5).

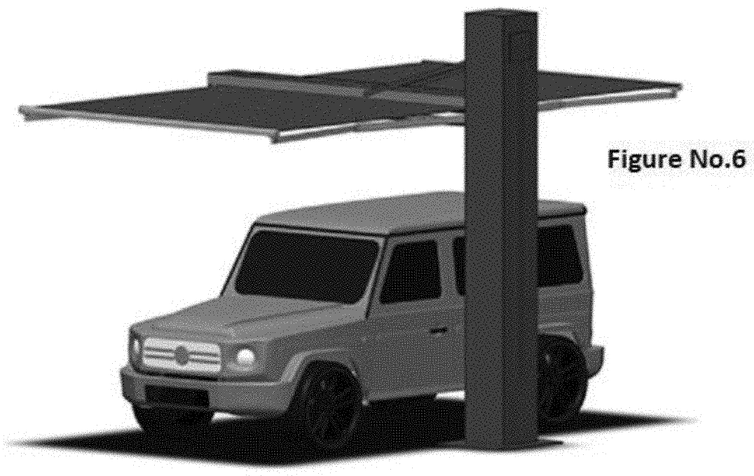

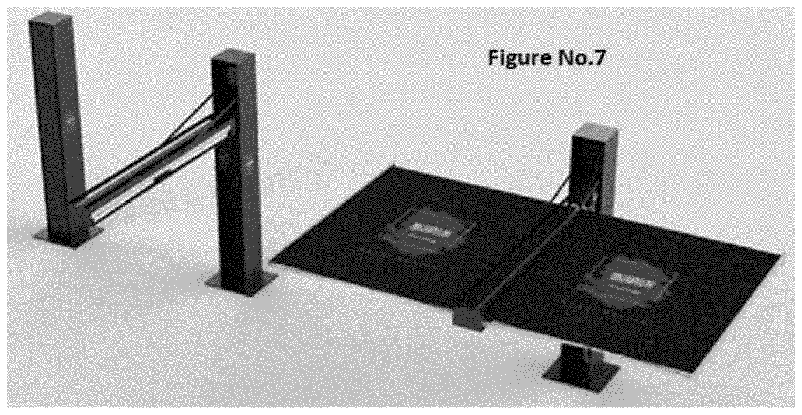

(FIG. 6) shows the final visualization of the shape of the awning that has been opened and the shade that was created by it on the vehicle. (FIG. 7) shows the three positions that are formed on opening and closing.

The closing process happens when the vehicle moves away from the awning, when it gets dark, when a strong wind blows, or when the shutdown button (FIG. 1 C) from the remote control is pressed.

These technical processes are processed through a processor (FIG. 1 P) programmed to operate according to the mentioned method inside the awning.

1- The invention is a device of an automatic electric solar awning with one pillar which is fixed on the ground (FIG. 1 D) or on a stable and strong wall. The awning is used to protect the vehicles from the sun rays and can also be used to shade the humans in the outdoor session by its shade. The size of the awning is not the same, but it can be made in multiple sizes depending on the size of the shade required. The awning operates in an innovative way as it is placed in multiple places such as the vehicle parking or the outdoor sessions. In case of closing, it looks like the lighting pole inside which there is the awning that does not occupy space. It operates innovatively as it begins to be opened and create the shade when the vehicle approaches the awning and stops under the awning. When the vehicle moves away from its place, it is automatically closed as no need for it. The awning will also get closed in case of the absence of sun or the presence of wind. Then, it reopens when the sun shines or the wind stops, provided the vehicle remains under the awning. Therefore, it is a smart awning that achieves the desired goals without any effort of the human intervention in opening and closing. If it is not needed, it does not constitute a distortion of the place. It is safe from falling when the air is strong.

2- The invention has the advantage of being only a pillar with an awning inside in case the awning is closed (FIG. 2). The awning operates either by pressing the buttons attached to the awning (FIG. 1 C) or by the remote control.

3- The device also has the advantage of operating as a code-reader sensor with radio frequency (RFID) (FIG. 1 K), as it begins to open automatically when the vehicle approaches and stops next to the pillar, as the code reader fixed on the pillar reads the symbol inside the vehicle, recognizes its presence and then opens. But provided that it is at the time of sunshine. The awning recognizes the presence of the sunshine by the sun sensor fixed in the awning (FIG. 1 H).

4- The awning gets closed in case of the absence of the sunshine or in the presence of the strong winds by the wind sensor fixed at the top of the awning (FIG. 1 G). The awning opens again when the sun shines again or the wind stops, provided that the vehicle is under the awning. It gets closed also if the vehicle moves away from its place. Therefore, it becomes an automatic awning which does not need any intervention to operate. It operates only if needed and in case of a danger from the wind it gets closed. All these processes are done by a programmed processor (FIG. 1 P) device fixed inside the awning that organizes them.

5- The electric-electronic solar awning operates in an innovative way on opening and closing through a mechanism on which the awning is designed and with parts that perform this. On opening, a cross-rail goes out from the fixed pillar lunging from the side outward (FIG. 3) and then rising (FIG. 4). Inside the cross-rail, there are two awnings (FIG. 1 E). The cross-rail is moved by a motor (FIG. 1 I) tied by the iron wire (FIG. 1 N) which is fixed with a chain (FIG. 1. O). The chain is fixed to a Sprocket with teeth (FIG. 1 J) from the top on which it is reeled. The iron wire is reeled on a toothless U Pulley (FIG. 1 L) from the bottom. The wire is connected to the cross-rail by a piece fixed to the bottom end (FIG. 1 M) of the cross-rail. The movement of the chain and the wire operates in a different direction, as the chain pulls the iron wire to raise the cross-rail to go out or pull it to come down.

6- After the height of the cross-rail is completed (FIG. 4), it is intercepted and hung to the pillar by two connections to fix the cross-rail (FIG. 1 B).

7- Then, it pushes arms (FIG. 1 S) fixed with two cylinders (FIG. 1 Q) and a fabric (FIG. 1 U) attached to them out in opposite directions (FIG. 1 F). The push is made because the arms are composed of a spring and a compressed chain (FIG. 1 T), but held by the fabric wrapped around the two cylinders (FIG. 1 Q) which are inside the cross-rail (FIG. 1 A). Inside them, there are two motors (FIG. 1 R) to push and attract for opening and closing, thus the awning is opened from one pillar (FIG. 5). On closing, all the moving parts return to their place, then the cross-rail returns to enter inside the pillar and becomes one stable pillar without appendages or barriers in place. Here is the visualization of the awning shape and its full stages (FIG. 7).

8- The invention has advantage that openings can be made in the fabric (FIG. 1 U) to reduce the movement of the wind helping the stability of the awning.
